(19) United States
(12) Patent Application Publication
(10) Pub. No.: US 2017/0334086 A1
(43) Pub. Date: Nov. 23, 2017

(54) CONTINUOUS PUNCHING METHOD

(71) Applicant: Charles CHEUNG, New Taipei City (TW)

(72) Inventor: Charles CHEUNG, New Taipei City (TW)

(21) Appl. No.: 15/581,106

(22) Filed: Apr. 28, 2017

(30) Foreign Application Priority Data
May 18, 2016 (TW) 105207260

(51) Int. Cl. B26F 1/40; B26F 1/44

(52) U.S. Cl. CPC B26F 1/40; B26F 1/44; B26F 2001/4481; B26F 2001/407

(57) ABSTRACT

A continuous punching method comprises: providing a sheet material, applying a first punching process of a first punch station to the sheet material, and applying a second punching process of a second punch station to the sheet material. The first punching process includes: adjusting a punching depth of a punch blade of the first punch station to determine a lateral length to be punched out by the punch blade, and forming two longitudinally spaced apart first punched slits on the sheet material through the punch blade. The second punching process includes: adjusting lateral positions of two punch blocks of the second punch station, and forming two laterally spaced apart second punched areas on the sheet material through the punch blocks. The two first punched slits and the two second punched areas communicate with each other to form a contour of a combined cut-out.

### FIELD OF THE INVENTION

The present invention relates to a continuous punching method, and more specifically, to a continuous punching method that is adjustable based on the dimension of cut-outs. The present invention also relates to a continuous punch apparatus utilizing said continuous punching method.

### BACKGROUND OF THE INVENTION

One of the numerous manufacturing processes for sheet metal is punching. A single cut-out on the sheet metal can be formed by either one-step punching or multi-station continuous punching. To achieve a desired cut-out, the punch block of the one-step punching and the punch blocks of the multi-station continuous punching have to match the dimension of the desired cut-out. In this case, a punch apparatus with various punch blocks is to be prepared, and the various punch blocks are switched when needed. This greatly increases the costs for several punch-and-die sets, operational time, and labor. In addition, it is required to use punch blocks of full dimension corresponding to each desired cut-out, so the usage amount of punch block material is increased.

As schematically shown in FIG. 1-(A), a conventional punch apparatus comprises a cylinder base 1, a punch holder 2, a punch block 3 mounted on the punch holder 2, and a lower punch base 4. A die is arranged on a frame base 5. A pneumatic or hydraulic cylinder 6 is arranged on the cylinder base 1 to provide actuating force for punching operations. When punching is performed, the punch block 3 punches through a sheet material 7 to obtain a desired cut-out. In the aforementioned case of the cut-out with different lengths, it is required to prepare multiple punch-and-die sets corresponding to the desired cut-out of similar shapes, in particular to prepare punch blocks 3, 3′ in different dimensions, as illustrated in FIGS. 1-(B) and (C).

TW M519020 U has disclosed a continuous punch apparatus with multiple punch stations. However, in this prior art reference, since several punch blocks are used to complete the exact dimension of the desired cut-out, the usage amount of the punch blocks cannot be reduced, and the corresponding punching force is large. This results in higher manufacturing costs.

Accordingly, the present invention is to provide an effective solution to the drawbacks of the conventional punch apparatus.

### SUMMARY

In accordance with a first aspect of the invention, a continuous punching method comprises: providing a sheet material, the sheet material having a longitudinal direction and a lateral direction, the sheet material being transported in the longitudinal direction; applying a first punching process of a first punch station to the sheet material, the first punch station including a punch blade; and applying a second punching process of a second punch station to the sheet material, the second punch station including two punch blocks. The first punching process includes: adjusting a punching depth of the punch blade to determine a lateral length to be punched out by the punch blade, and forming two longitudinally spaced apart first punched slits on the sheet material through the punch blade in sequence via the transportation of the sheet material. The second punching process includes: adjusting lateral positions of the punch blocks, and forming two laterally spaced apart second punched areas on the sheet material through the punch blocks. The two first punched slits and the two second punched areas communicate with each other to form a contour of a combined cut-out.

In accordance with a second aspect, the continuous punch apparatus according to the first aspect is configured so that the punch blade of the first punch station has an increasing punching cross-section along a perpendicular direction away from the sheet material.

In accordance with a third aspect, the continuous punch apparatus according to the first or second aspect is configured so that the punch blade of the first punch station has a blade tip in its middle with a predetermined angle.

In accordance with a fourth aspect, the continuous punch apparatus according to the first or second aspect is configured so that the adjustment of the punching depth of the punch blade corresponds to the adjustment of the lateral positions of the punch blocks, such that the first punched slits and the second punched areas communicate with each other.

In accordance with a fifth aspect, the continuous punch apparatus according to the first or second aspect is configured so that the step of applying the first punching process of the first punch station to the sheet material is prior to the step of applying the second punching process of the second punch station to the sheet material.

In accordance with a sixth aspect, the continuous punch apparatus according to the first or second aspect is configured so that the step of applying the second punching process of the second punch station to the sheet material is prior to the step of applying the first punching process of the first punch station to the sheet material.

In accordance with yet another aspect of the invention utilizing the methods mentioned above, a continuous punch apparatus comprises a first punch station and a second punch station. The first punch station includes a punch blade to form two longitudinally spaced apart first punched slits on a sheet material. The punch blade of the first punch station has a laterally increasing punching cross-section along a perpendicular direction away from the sheet material. A punching depth of the punch blade is adjustable to determine a lateral length for each of the first punched slits. The second punch station includes two punch blocks to form two laterally spaced apart second punched areas on the sheet material. Lateral positions of the punch blocks are adjustable to determine a lateral distance between the second punched areas. The two first punched slits and the two second punched areas communicate with each other to form a contour of a combined cut-out.

Other goals, features and advantages of the present invention will become apparent to those skilled in the art from the following detailed description and the drawings.

### BRIEF DESCRIPTION OF THE DRAWINGS

A more complete appreciation of the present invention will be better understood by reference to the following detailed description when considered in connection with the accompanying drawings.

FIG. 1 schematically illustrates a conventional punch apparatus, in which part (A) is a front view of the conventional apparatus, part (B) is a cross-sectional view of a punch block taken along line A-A, and part (C) is a cross-sectional view of another punch block in different dimension taken along line A-A.

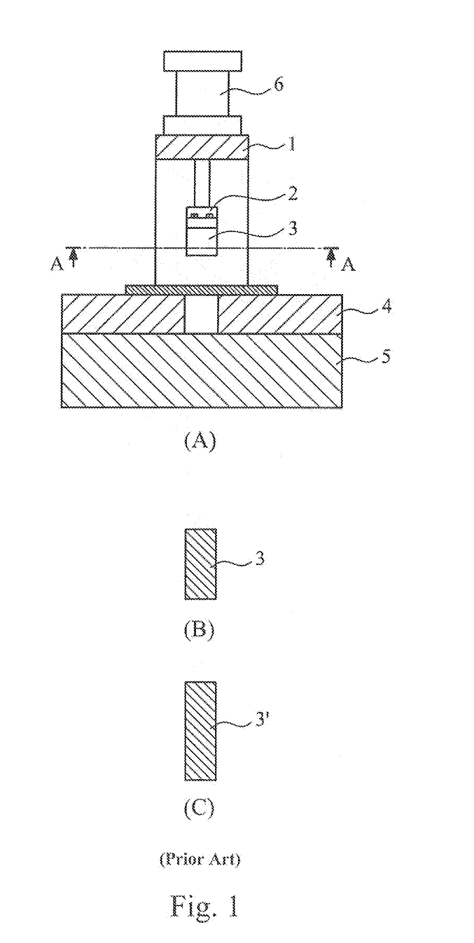

FIG. 2 is a schematic perspective view of a continuous punch apparatus according to an embodiment of the present invention. The continuous punch apparatus includes a first punch station and a second punch station.

FIG. 3 is a plan view of the continuous punch apparatus illustrated in FIG. 2.

FIG. 4 shows a schematic view of the punched regions of the sheet material by the punch blade and the punch blocks.

FIG. 5 shows the operation of the first punch station as shown in FIG. 3, in which part (A) is a is a cross-sectional view of the punch block and the sheet material taken along line B-B of FIG. 3, and part (B) is a plan view of the sheet material after being punched.

FIG. 6 shows the front view of the punch blade and the sheet material in the punching state.

FIG. 7 shows the operation of the second punch station as shown in FIG. 3, in which part (A) is a is a cross-sectional view of the punch block and the sheet material taken along line B-B of FIG. 3, and part (B) is a plan view of the sheet material after being punched.

### DETAILED DESCRIPTION

Embodiments of the present invention will be described with reference to the drawings. It will be apparent to those skilled in the art that the description below for the embodiments is for the purpose of illustration only, and not for the purpose of limiting the scope of the invention.

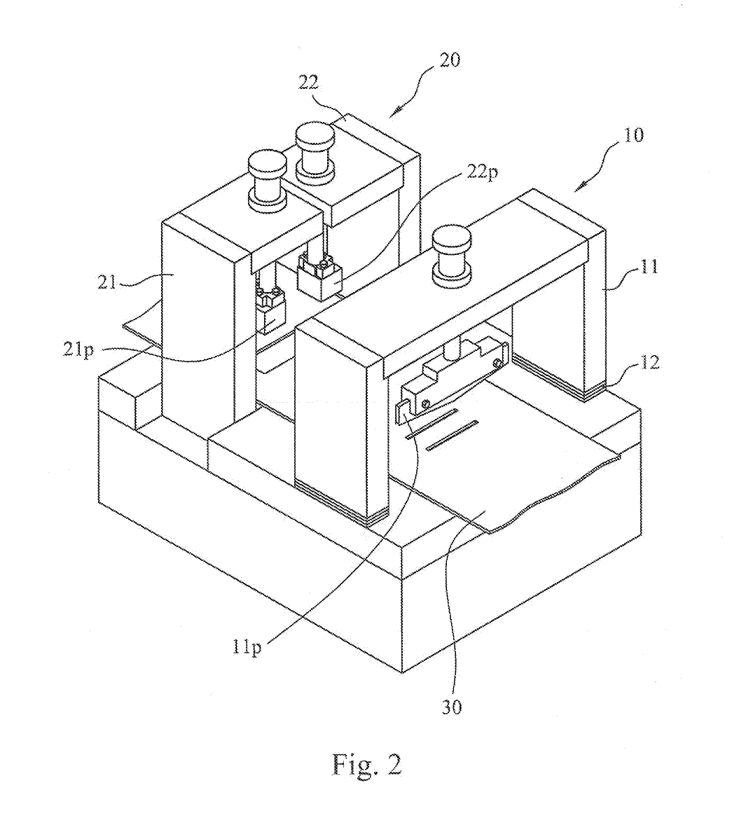

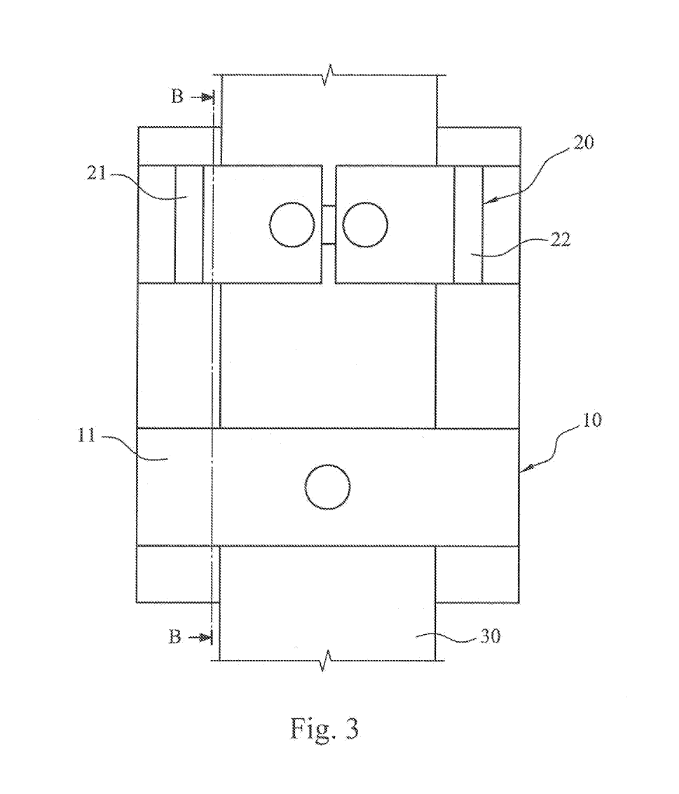

Initially referring to FIGS. 2 and 3, a continuous punch apparatus according to a first embodiment of the present invention includes a first punch station 10 and a second punch station 20. The first punch station 10 includes a first punching assembly 11. The first punching assembly 11 is provided with a punch blade 11p that is coupled to a pneumatic or hydraulic cylinder to apply a punching process to a sheet material 30 in a first stage. The second punch station 20 includes a second punching assembly 21 and a third punching assembly 22 that are laterally spaced apart. The second punching assembly 21 and the third punching assembly 22 are provided with punch blocks 21p and 22p respectively, which are coupled to pneumatic or hydraulic cylinders to apply a punching process to a sheet material 30 in a second stage after the first punch station 10 performs the punching process in the first stage. Accordingly, with the first punch station 10 and the second punch station 20 punching at the same place of the sheet material 30, a contour of a combined cut-out contour 30c is obtained.

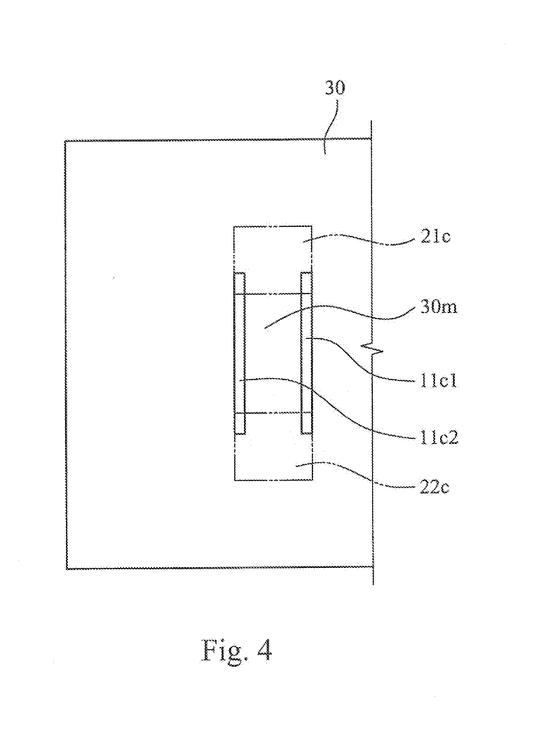

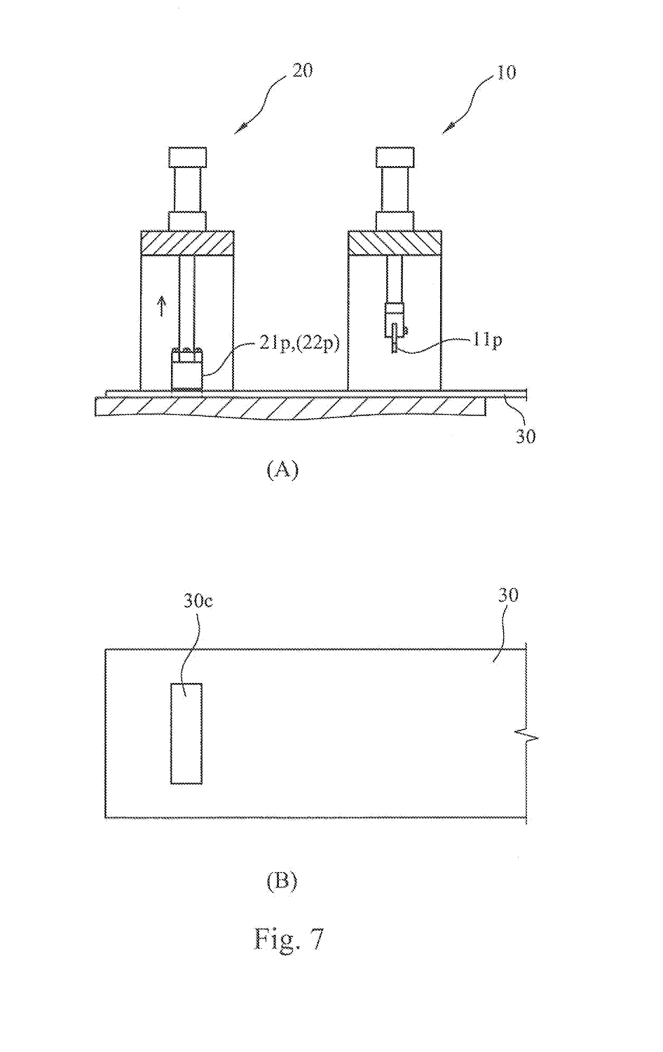

Referring to FIG. 4, the punch blade 11p of the first punching assembly 11 punches through the sheet material 30 to form two punched slits 11c1 and 11c2 that are longitudinally spaced apart via the transportation of the sheet metal 30. Then, when the position of the sheet material 30 previously processed by the first punching assembly 11 is transported to the second punching assembly 12, another punching process is performed at the ends of the punched slits 11c1 and 11c2 to form two punched areas 21c and 22c that are laterally spaced part, thereby the two punched slits 11c1 and 11c2 and the two punched areas 21c and 22c communicate with each other to form the contour of the combined cut-out. A middle material portion 30m that is no longer connected to the sheet material 30 within the contour of the combined cut-out falls off and is discarded. As a result, the combined cut-out 30c is completed on the sheet material 30 (see FIG. 7). The two punched slits 11c1 and 11c2 is adapted with dimensioning and positioning to correspond to the two punched areas 21c and 22c, in order to complete the contour of the desired combined cut-out 30c.

With a material feeding structure constituted of servomotors, precise belts, gears, and chains (not shown), the sheet material 30 can be transported to the second punch station 20 from the first punch station 10 for precise positioning and punching in the two stages. A person of ordinary skill in the art will appreciate that the second punch station 20 may be placed before the first punch station 10. In this case, the two punched areas are formed prior to the formation of the two punched slits.

Referring back to FIG. 2, the first punching assembly 11 of the first punch station 10 is a punch tool that can be adjusted vertically via padding blocks 22. This is done by using padding blocks 22 under the base of the first punching assembly 11 to adjust the height of the first punching assembly 11, and thus the resting position of the punch blade 11p of the first punching assembly 11 can be changed with respect to the sheet material 30. The second and third punching assemblies 21 and 22 of the second punch station 20 are laterally adjusted along guide rails for adjustment of lateral positions. The second and third punching assemblies 21 and 22 are fixed in place by bolts or positioning pins.

The positional adjustment of the first, second and third punching assemblies 11, 21 and 22 is not limited to the means discussed above, and can be carried out by other mechanical, electrically actuated, or hydraulic means.

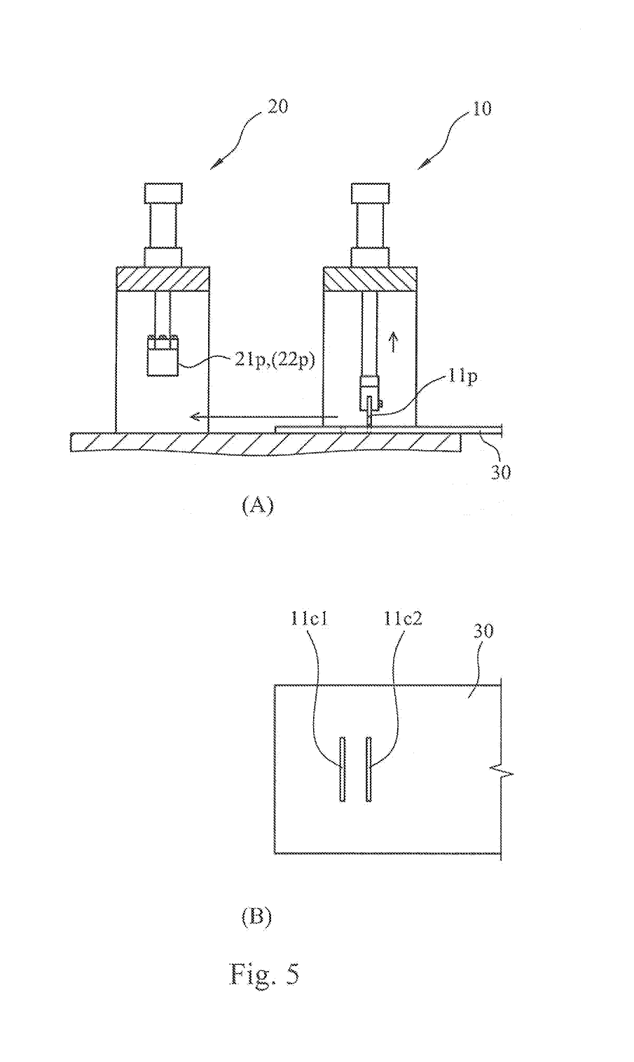

Referring to FIG. 5, the operation of the first punch station 10 is shown, in which part (A) is a is a cross-sectional view of the punch blade 11 and the sheet material 30 taken along line B-B of FIG. 3, and part (B) is a plan view of the sheet material after being punched. When a punching operation is performed by the first punching assembly 11, the punch blade 11p punches through the sheet material 30 twice to form the two punched slits 11c1 and 11c2. In this stage, the punched slit 11c1 is formed by the punch blade 11p of the first punching assembly 11. Then, the sheet material 30 is moved forward, and thus the punched slit 11c2 is formed by the punch blade 11p of the first punching assembly 11 after the punched slit 11c1. The distance between the punched slits 11c1 and 11c2 is determined by the movement of the sheet material 30. In another case, for example, the first punching assembly may be equipped with two punch blades to form the two punched slits.

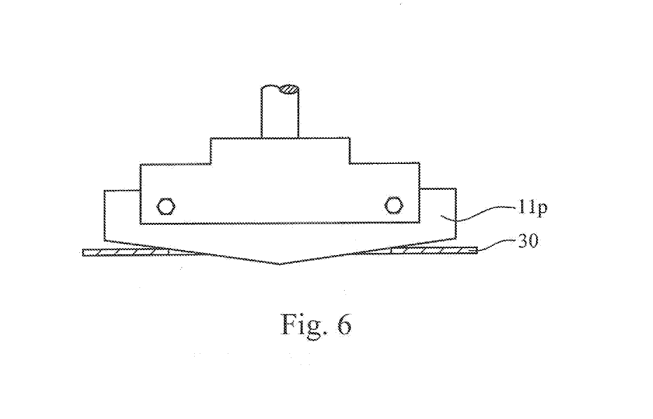

As seen in FIG. 6, the punch blade 11p of the punching assembly 11 is tapered in the lateral direction so as to have a laterally increasing punching cross-section (profile) along the perpendicular direction away from the sheet material 30. Preferably, the punch blade 11p of the first punching assembly 11 has a blade tip in its middle with a predetermined angle. The angle of the blade tip may range from approximate 90 degree to 170 degree. For a larger angle of the blade tip, a significant change in the length of the punched slits will be obtained in response to a minor change in the punching depth. For a smaller angle of the blade tip, although a larger punching depth is required for a significant change in the length of the punched slits, the smaller angle of the blade tip has a higher ability for the punch blade to punch through the sheet material.

Since the punch blade 11p has increasing punching cross-section, the length of the punched slits becomes longer when the punch blade 11p punches deeper. In this embodiment, the punch stroke of the first punching assembly 11 is maintained, and the punching depth is determined by the vertical position of the first punching assembly 11. When the first punching assembly 11 is elevated, a shorter punched length is obtained with the smaller punch depth. When the first punching assembly 11 is lowered, a longer punched length is obtained with the larger punch depth. However, in another case that the vertical position of the first punching assembly 11 is maintained, the traveling distance of the punching stroke can be adjusted for different slit lengths.

In the manufacturing of C-beam, the lengths of cutouts often used on sheet materials are 75, 89, 100, 120, 140 mm, etc. One single punch blade can be used to form these lengths. For longer lengths such as 200, 250, 300, 350 mm, etc., another punch blade can be used to form these longer lengths. Accordingly, there is no need to prepare various punch blocks.

Next, referring to FIG. 7 that illustrates the schematic view of the operation of the second punch station 20, part (A) is a cross-sectional view of the punch blocks and the sheet material taken along line B-B of FIG. 3, and part (B) is a plan view of the sheet material after being punched in part (A). After being processed by the first punching assembly 10, the sheet material 30 is transported to the second punch station 20 for the second punching process. Referring to FIGS. 4 and 7, the punch blocks 21p and 22p of the second and third punching assemblies 21 and 22 punch through the sheet material 30 to form the two punched areas 21c and 22c at the ends of the punched slits 11c1 and 11c2. The lateral distance between the punched areas 21c and 22c are changed by adjusting the lateral positions of the second and third punching assemblies 21 and 22. The first punched slits 11c1 and 11c2 formed by the first punch station 10 communicates with the second punched areas 21c and 22c formed by the second punch station 20 to form the contour of the combined cut-out 30c. A middle material portion 30m that is no longer connected to the sheet material 30 falls off.

It will be appreciated that the combined cut-out 30c is not necessarily the final shape of the cutout. That is, the continuous punch apparatus may comprise one or more punch stations to form other punched areas at the circumference of the combined cut-out 30c or other unpunched regions.

With the first and second punch stations 10 and 20 according to this embodiment, they can be adjusted to form smaller or larger cut-outs as needed. These cut-outs have substantially the same shape at their lateral end with different lengths in the middle. Therefore, the total area of the punched slits and the punched areas is less than the total area of the desired cut-out, and the dimension of the desired cut-out can be adjusted. In terms of a single cut-out, the disadvantage of punch blocks of full dimension can be avoided. In terms of cut-outs with different shapes, the disadvantage of preparing various punch blocks and punch assemblies can be avoided. The use of punch blades instead of punch blocks also facilitates decreasing the punching force.

According to yet another embodiment (not shown) of the present invention, contrary to the first embodiment, the second punch station 20 utilized for forming the punched areas at lateral ends may be placed before the first punch station 10 utilized for forming the punched slits between the punched areas. A person of ordinary skill in the art will appreciate the details of the positional switch, and thus will not be discussed here for the sake of brevity.

In understanding the scope of the present invention, the term “comprising” and its derivatives, as used herein, are intended to be open ended terms that specify the presence of the stated features, elements, components, groups, and/or integers, but do not exclude the presence of other unstated features, elements, components, groups, and/or integers. Also, an element when described in the singular can have the dual meaning of a single part or a plurality of parts.

As used herein to describe the above embodiment(s), the following directional terms “lateral”, “vertical”, “center”, “upward”, “downward”, etc are determined based on the plane of the sheet material as reference. Therefore, the disclosures also apply to vertical, horizontal, or other types of punch apparatus.

Also, it will be understood that while the terms “first” and “second” recited herein are to describe various elements, these elements should not be limited by a particular order of the ordinal numbers. The ordinal numbers are used to distinguish one element from another element. Moreover, the terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes, modifications and replacements can be made herein without departing from the scope of the invention as defined in the appended claims. For example, unless specifically described otherwise, the size, shape, position or orientation of the various components can be changed as needed and/or desired, as long as such change does not substantially affect the expected action or function. Components that are shown directly connected or contacting each other may have intermediate structures disposed between them without affecting the expected function. A single component illustrated as integrally formed may be one single part, or combined by multiple sub-parts. The functions of one element may be performed by two, and vice versa, unless specifically limited. The structures and functions of one embodiment may be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### LIST OF REFERENCE CHARACTERS OF MAJOR ELEMENTS

1: cylinder base
2: punch holder
3: punch block
3′: punch block
4: lower punch base
5: frame base
6: cylinder
7: sheet material
10: first punch station
11: first punching assembly
11c1: punched slit
11c2: punched slit
11p: punch blade
12: padding block
20: second punch station
21: second punching assembly
21c: punched area
21p: punch block
22: third punching assembly
22c: punched area
22p: punch block
30: sheet material
30c: combined cut-out
A: cross-section line
B: cross-section line

What is claimed is:

1. A continuous punching method comprising:
providing a sheet material, the sheet material having a longitudinal direction and a lateral direction, the sheet material being transported in the longitudinal direction;
applying a first punching process of a first punch station to the sheet material, the first punch station including a punch blade, the first punching process including:
adjusting a punching depth of the punch blade to determine a lateral length to be punched out by the punch blade, and
forming two longitudinally spaced apart first punched slits on the sheet material through the punch blade in sequence via the transportation of the sheet material,
applying a second punching process of a second punch station to the sheet material, the second punch station including two punch blocks, the second punching process including:
adjusting lateral positions of the punch blocks, and
forming two laterally spaced apart second punched areas on the sheet material through the punch blocks, and
wherein the two first punched slits and the two second punched areas communicate with each other to form a contour of a combined cut-out.

2. According to the continuous punching method of claim 1, wherein the punch blade of the first punch station has an increasing punching cross-section along a perpendicular direction away from the sheet material.

3. According to the continuous punching method of claim 2, wherein the punch blade of the first punch station has a blade tip in its middle with a predetermined angle.

4. According to the continuous punching method of claim 2, wherein the adjustment of the punching depth of the punch blade corresponds to the adjustment of the lateral positions of the punch blocks, such that the first punched slits and the second punched areas communicate with each other.

5. According to the continuous punching method of claim 2, wherein the step of applying the first punching process of the first punch station to the sheet material is prior to the step of applying the second punching process of the second punch station to the sheet material.

6. According to the continuous punching method of claim 2, wherein the step of applying the second punching process of the second punch station to the sheet material is prior to the step of applying the first punching process of the first punch station to the sheet material.

7. A continuous punch apparatus comprising:
a first punch station including a punch blade to form two longitudinally spaced apart first punched slits on a sheet material, the punch blade of the first punch station having a laterally increasing punching cross-section along a perpendicular direction away from the sheet material, a punching depth of the punch blade being adjustable to determine a lateral length for each of the first punched slits; and
a second punch station including two punch blocks to form two laterally spaced apart second punched areas on the sheet material, lateral positions of the punch blocks being adjustable to determine a lateral distance between the second punched areas,
wherein the two first punched slits and the two second punched areas communicate with each other to form a contour of a combined cut-out.
